(19) United States
(12) Patent Application Publication
(10) Pub. No.: US 2013/0051888 A1
(43) Pub. Date: Feb. 28, 2013

(54) DOUBLE-SIDED ADHESIVE TAPE

(71) Applicant: Takahiro NORIMATSU, Hekinan-shi (JP)

(72) Inventor: Takahiro NORIMATSU, Hekinan-shi (JP)

(73) Assignee: BROTHER KOGYO KABUSHIKI KAISHA, Nagoya-shi (JP)

(21) Appl. No.: 13/595,471

(22) Filed: Aug. 27, 2012

(30) Foreign Application Priority Data
Aug. 31, 2011 (JP) 2011-189643
Aug. 31, 2011 (JP) 2011-189644
Aug. 31, 2011 (JP) 2011-189645

(51) Int. Cl. B41J 33/10; B32B 27/08; B32B 37/10; C09J 7/02

(52) U.S. Cl. 400/194; 428/41.3; 156/60

(57) ABSTRACT

A double-sided adhesive tape rolled on a cylindrical roll core includes a polyethylene terephthalate film having a first surface and a second surface opposite to the first surface, a first adhesive layer applied on the first surface of the polyethylene terephthalate film, a release sheet laminated on the first surface of the polyethylene terephthalate film through the first adhesive layer, the release sheet being laminated so as to turn exterior to the polyethylene terephthalate film, and a second adhesive layer applied on the second surface of the polyethylene terephthalate film. In the double-sided adhesive tape, 100 N/m or larger of tensile force is applied to the polyethylene terephthalate film when the release sheet is laminated onto the first adhesive layer applied on the first surface of the polyethylene terephthalate film.

### CROSS-REFERENCE TO RELATED APPLICATIONS

The present application claims priority from Japanese Patent Application Nos. JP 2011-189643, JP 2011-189644 and JP 2011-189645 all of which were filed on Aug. 31, 2011, the disclosures of which are incorporated herein by reference in its entirety.

### TECHNICAL FIELD

The disclosure relates to a double-sided adhesive tape that is rolled on a roll core, formed of polyethylene terephthalate (PET) film as substrate thereof, and defined by an unusable portion and a usable portion wherein the unusable portion accounts for one range to reach predetermined length of distance from the roll core and the usable portion accounts for other range to exceed the predetermined length of distance over the unusable portion that begins from the roll core. The disclosure especially relates to the double-sided adhesive tape capable of preventing the PET film from bearing a wrinkle at the usable portion.

### BACKGROUND

There have conventionally been proposed various double-sided adhesive tapes configured to include a substrate, two of adhesive layers disposed on a top surface and a bottom surface of the substrate and a release sheet disposed on either one of the two of adhesive layers.

For instance, JP Laid-open Patent Application Publication No. 5-140520 discloses a double-sided adhesive tape obtained by adhering an adhesive layer of a release sheet onto one surface of a substrate with a transfer roll and further transferring an adhesive layer of a process sheet onto other surface of the substrate with another transfer roll. The double-sided adhesive tape as mentioned above employs a substrate made of nonwoven fabric of which primary ingredient is hemp. When the adhesive layer adhered to the release sheet is laminated on the substrate, the substrate is pulled in longitudinal directions so as to expand its length by 0.20 to 0.50% longer. The double-sided adhesive tape thus fabricated is capable of avoiding occurrence of a wrinkle in its inner adhesive layer or curling itself.

As to a typical double-sided adhesive tape rolled on a roll core, a substrate and a release sheet are bonded together by intervention of an adhesive layer. Above such configuration naturally creates circumferential difference between circumferential length of a substrate and that of a release sheet because the release sheet is made to turn exterior to the substrate when the double-sided adhesive tape is rolled on the core. Consequently, the circumferential length of the substrate made to turn interior to the release sheet has extra length and wrinkles occur in the substrate.

In a case where a double-sided adhesive tape is rolled on a core, a substrate made to turn interior to a release sheet cannot help bearing a wrinkle. Accordingly, the double-sided adhesive tape of JP Laid-open Patent Application Publication No. 5-140520 can possibly bear a wrinkle at its substrate side while being kept in storage. It is significantly difficult to thoroughly avoid occurrence of a wrinkle in the substrate side.

### SUMMARY

The disclosure has been made to solve the above-described problem. Also, the object of the disclosure is to provide a double-sided adhesive tape capable of preventing the PET film from bearing a wrinkle.

To achieve the object of the disclosure, there is provided a double-sided adhesive tape rolled on a cylindrical roll core, the double-sided adhesive tape comprising: a polyethylene terephthalate film having a first surface and a second surface opposite to the first surface; a first adhesive layer applied on the first surface of the polyethylene terephthalate film; a release sheet laminated on the first surface of the polyethylene terephthalate film through the first adhesive layer, the release sheet being laminated so as to turn exterior to the polyethylene terephthalate film; and a second adhesive layer applied on the second surface of the polyethylene terephthalate film; wherein 100 N/m or larger of tensile force is applied to the polyethylene terephthalate film when the release sheet is laminated onto the first adhesive layer applied on the first surface of the polyethylene terephthalate film.

In the double-sided adhesive tape directed to the disclosure, since 100 N/m or larger of tensile force is applied to the polyethylene terephthalate film when the release sheet is laminated onto the first adhesive layer applied on the one surface of the polyethylene terephthalate film, the polyethylene terephthalate film can be prevented from bearing a wrinkle therein.

### BRIEF DESCRIPTION OF THE DRAWINGS

FIG. 1 is a schematic cross-sectional view of a double-sided adhesive tape directed to the present embodiment;

FIG. 2 is a schematic view for illustrating a double-sided adhesive tape maker;

FIG. 3 is a graph for illustrating relation between tensile force applied on a PET (polyethylene terephthalate) film and tape length from a roll core to a wrinkle in the tape;

FIG. 4 is a view for schematically illustrating curling states of tape pieces after being kept under predetermined condition, each of the tape pieces being obtained by cutting off a double-sided adhesive tape by predetermined length;

FIG. 5 is a graph for illustrating relation between: curling state of tape pieces obtained by cutting off the respective double-sided adhesive tapes by the predetermined length and being kept under the predetermined condition; and tape length from a roll core to a wrinkle in the tape;

FIG. 6 is a graph for schematically illustrating relation between: length difference of a PET film and a release sheet making up a predetermined length of a double-sided adhesive tape, the length difference being measured under predetermined condition; and tape length from a roll core to a wrinkle in the tape; and

FIG. 7 is a plan view of a tape cassette that employs the double-sided adhesive tape directed to the present embodiment.

### DETAILED DESCRIPTION

Next, there will be described on an embodiment of a double-sided adhesive tape directed to the disclosure by referring to drawings.

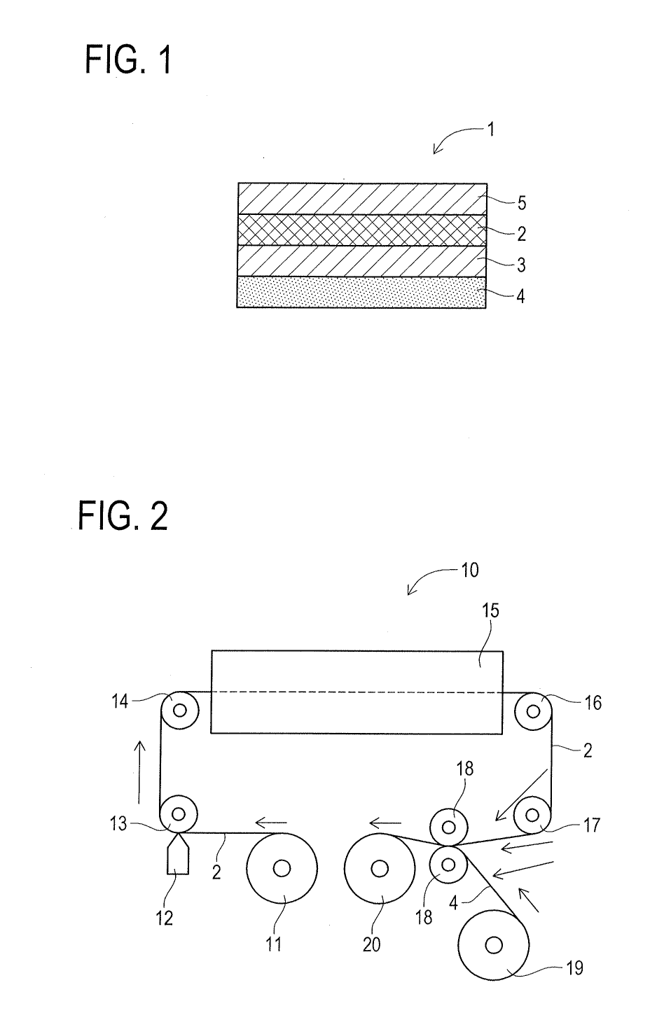

Firstly, configuration of the double-sided adhesive tape of the present embodiment will be described by referring to FIG. 1. A double-sided adhesive tape 1 of the present embodiment is essentially comprised of: a PET (polyethylene terephthalate) film 2 as substrate film; a first adhesive layer 3 that is applied onto one surface of the PET film 2 (lower surface in FIG. 1); a release sheet 4 pasted onto the first adhesive layer 3; and a second adhesive layer 5 that is applied onto the other surface of the PET film 2 (upper surface in FIG. 1).

The PET film 2 is a 12 μm-thick transparent film. Ingredients in common with the first adhesive layer 3 and the second adhesive layer 5 are mixture of solvent-type acrylic pressure sensitive adhesive agent (50% of solids contents, 5000 cps of viscosity) and ethyl acetate as diluent. The thus obtained mixture is applied onto the upper surface and the lower surface of the PET film 2 so as to form the first adhesive layer 3 and the second adhesive layer 5. In this connection, 1.0 part by weight of solvent-type acrylic pressure sensitive adhesive and 20 parts by weight of ethyl acetate are mixed into 100 parts by weight of adhesive agent.

The release sheet 4 is made from glassine paper with 55 μm thickness, on both planes of which silicone processing is done.

Next, there will be described on manufacturing method of the double-sided adhesive tape 1 directed to the present embodiment. The double-sided adhesive tape 1 is manufactured by a double-sided adhesive tape maker 10. In FIG. 2, the double-sided adhesive tape maker 10 includes a film feeding roll 11 onto which the PET film 2 is rolled and the PET film 2 is fed from the film feeding roll 11.

At the downstream of the film feeding roll 11, there are arranged: a coater head 12 for coating with adhesive agent the one surface (lower surface in FIG. 2) of the PET film 2 that is fed from the film feeding roll 11; and a conveying roller 13 that faces the coater head 12. It is to be noted that the coater head 12 is comprised of a so-called die coater and by adjusting gap of the die coater, adhesive agent is applied and dried so as to obtain a 20 μm-thick first adhesive layer 3 after dried.

At the downstream of the coater head 12 and the conveying roller 13, there is arranged a conveying roller 14 for changing conveying direction of the PET film 2. At the downstream of the conveying roller 14, there is arranged a drying oven 15 of which maximum inner temperature is set to 100 degrees Celsius. Direction for the PET film 2 to be conveyed is changed by the conveying roller 14 so as to bring the PET film 2 into the drying oven 15. The adhesive agent applied onto the one surface of the PET film 2 is dried during the PET film 2 passing the drying oven 15 and formed into a 20 μm-thick first adhesive layer 3.

At the downstream of the drying oven 15, there are arranged a conveying roller 16, a conveying roller 17 and a pair of laminating rollers 18, 18. The PET film 2 dried by the drying oven 15 is conveyed by the conveying rollers 16 and 17. Direction for the dried PET film 2 to be conveyed is changed by the conveying rollers 16 and 17 so as to feed the PET film 2 to the pair of laminating rollers 18, 18. It is to be noted that speed for the pair of laminating rollers 18, 18 to convey the PET film 2 is set faster than speed for the conveying roller 17 to convey the PET film 2 in order to apply tensile force to the PET film 2. The rotation speed of the pair of laminating rollers 18, 18 and that of the conveying roller 17 are adjusted variously so that tensile force on the PET film 2 can be changed at various levels. Application of tensile force to the PET film 2 at various levels can be implemented by taking various methods.

Further, a release sheet feeding roll 19 with a release sheet 4 being rolled thereon is arranged in the vicinity of the pair of laminating rollers 18, 18 so that the release sheet 4 is fed from the release sheet feeding roll 19 to the path between the pair of laminating rollers 18, 18.

As mentioned in the above, the PET film 2 is fed to the pair of laminating roller 18, 18 while tensile force is applied thereto. Concurrently with the above feed of the PET film 2, the release sheet 4 is fed from the release sheet feeding roll 19 to the pair of laminating roller 18, 18 so that the first adhesive layer 3 of the PET film 2 and the release sheet 4 are laminated together through the path between the pair of laminating rollers 18, 18.

Thus, the release-sheet-attached tape obtained by laminating the release sheet 4 on one surface of the PET film 2 with intervention of the first adhesive layer 3 is taken up into a take-up roll 20 arranged at the downstream of the pair of laminating rollers 18, 18.

The above mentioned series of process completes the release-sheet-attached tape obtained by laminating the release sheet 4 on one surface of the PET film 2 with intervention of the first adhesive layer 3. Thereafter, a second adhesive layer 5 is applied onto the other surface of the PET film 2, the other surface being the reverse of the one surface of the PET film 2 to which the first adhesive layer 3 is applied.

Application and formation of the second adhesive layer 5 is realized by using the double-sided adhesive tape maker 10. For instance, instead of the film feeding roll 11, the take-up roll 20 with the release-sheet-attached tape being rolled thereon shall be set at the location of the film feeding roll 11 so that the other surface, the reverse of the surface coated with the first adhesive layer 3, should face the coater head 12. The other surface, the reverse of the surface coated with the first adhesive layer 3, is coated with adhesive agent by using the coater head 12 so as to obtain 20 μm thickness after dried. Thereafter, the PET film 2 is fed to the drying oven 15 by the conveying rollers 13 and 14 so as to dry the adhesive agent and obtain the second adhesive layer 5. Thereafter, the resultant tape is taken up onto a take-up roll by the aid of the conveying rollers 16, 17 and the pair of laminating rollers 18, 18. Thus, there can be manufactured the double-sided adhesive tape 1 formed of: the PET film 2; the first adhesive layer 3 that is applied onto one surface of the PET film 2; the release sheet 4 that is laminated on the first adhesive layer 3; and the second adhesive layer 5 that is applied onto the other surface of the PET film 2.

The double-sided adhesive tape 1 as described above is generally manufactured on the scale of 1000 mm tape width and 1000 m roll length as original scale tape of the double-sided adhesive tape. The one manufactured as original scale tape undergoes aging treatment for 48 hours at temperature of 40 degrees Celsius.

The original scale tape is cut into medium-sized double-sided adhesive tapes to obtain medium rolls each having 36 mm-6 mm tape width and approximately 1000 m of roll length in rolled onto a core.

Further, a medium roll of the double-sided adhesive tape is cut into small rolls each having 36 mm-6 mm tape width (the same as width of the medium roll) and 9 m of roll length rolled onto a core of which major diameter is 12 mm.

The thus obtained small roll of double-sided adhesive tape is used as tape to be accommodated in a tape cassette for a tape printing apparatus to be described later.

For forming a small roll by rolling the double-sided adhesive tape 1 onto periphery of a roll core, the double-sided adhesive tape 1 is rolled so as to make the second adhesive layer 5 and the release sheet 4 turn inward and outward, respectively, with reference to the roll core. When the double-sided adhesive tape 1 is rolled, there arises length difference between circumferential length of the PET film 2 and that of the release sheet 4. The circumferential length difference between them is likely to cause the PET film 2 to bear a wrinkle. Once a wrinkle occurs, adhesive property of the double-sided adhesive tape 1 deteriorates at the wrinkled portion and neatness is spoiled in a case where the double-sided adhesive tape 1 is used visibly and recognizably.

As described previously, there has been taken conventional countermeasure against occurrence of a wrinkle, in such a manner that tensile force is applied to the PET film 2 at the moment of laminating the first adhesive layer 3 and the release sheet 4 on the PET film 2 for fabricating the original scale tape. The original scale tape fabricated in the above manner is scaled down to a medium roll and further down to a small roll of the double-sided adhesive tape 1 and it has actually been recognized that the thus finally fabricated small roll of the double-sided adhesive tape 1 can avoid occurrence of a wrinkle to some extent owing to the tensile force previously applied to the PET film 2 that absorbs difference between circumferential length of the PET film 2 and that of the release sheet 4.

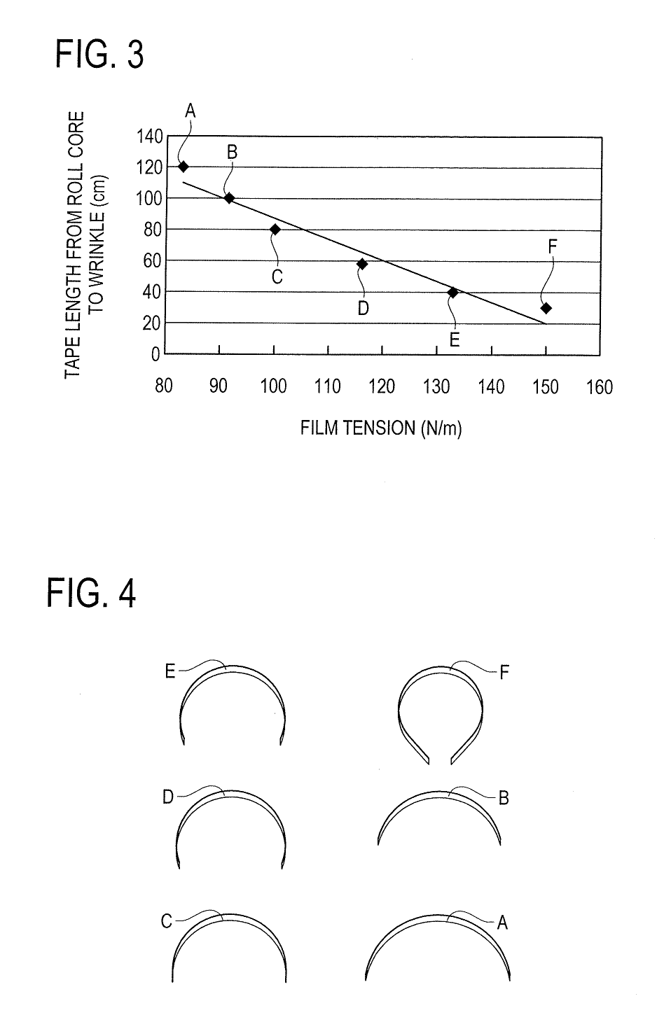

Here, for experiments, there have been prepared six kinds of original scale tapes fabricated by varying tensile force to be applied on the PET film 2 at the moment of laminating the first adhesive layer 3 and the release sheet 4 thereon. From the six kinds of original scale tapes, six kinds of small rolls A through F have been fabricated and those six kinds of small rolls A through F have been used for the experiments to find relation between tensile force applied to a PET film 2 at the moment of fabricating the original scale tape and a wrinkle-occur portion with respect to each of the small rolls A through F. A graph in FIG. 3 shows experiment results.

Of the graph in FIG. 3, the abscissa indicates per tape width of tensile force (N/m) applied to the PET film 2 at the moment of laminating the release sheet 4 on the PET film 2 to fabricate the original scale tape and the ordinate indicates tape length (cm) from a roll core to a portion that bears a wrinkle at outermost periphery of respective small rolls of double-sided adhesive tape 1.

With respect to a double-sided adhesive tape 1 rolled onto a small roll, a range to reach 100 cm from a roll core of the tape is defined as an unusable portion and another range to exceed 100 cm over the unusable portion that begins from the roll core is defined as a usable portion to be practically used as double-sided adhesive tape.

The point A shown in FIG. 3 accounts for an experiment result with respect to a small roll A and the experiment result has been obtained by taking the following steps: fabricating an original scale tape by applying 83.1 N/m of tensile force onto a PET film 2; as samples for the experiment, making twenty of small rolls A from the thus fabricated original scale tape; and calculating an average value of length from a roll core to a wrinkle in the tape with respect to the twenty of small rolls A. Similarly, the point B accounts for an experiment result with respect to a small roll B and the experiment result has been obtained by taking the following steps: fabricating an original scale tape by applying 91.4 N/m of tensile force onto a PET film 2; as samples for the experiment, making twenty of small rolls B from the thus fabricated original scale tape; and calculating an average value of length from a roll core to a wrinkle in the tape with respect to each of the twenty of small rolls B. Similarly, the point C accounts for an experiment result with respect to a small roll C and the experiment result has been obtained by taking the following steps: fabricating an original scale tape by applying 99.7 N/m of tensile force onto a PET film 2; as samples for the experiment, making twenty of small rolls C from the thus fabricated original scale tape; and calculating an average value of length from a roll core to a wrinkle in the tape with respect to the twenty of small rolls C. Similarly, the point D accounts for an experiment result with respect to a small roll D and the experiment result has been obtained by taking the following steps: fabricating an original scale tape by applying 116.3 N/m of tensile force onto a PET film 2; as samples for the experiment, making twenty of small rolls D from the thus fabricated original scale tape; and calculating an average value of length from a roll core to a wrinkle in the tape with respect to the twenty of small rolls D. Similarly, the point E accounts for an experiment result with respect to a small roll E and the experiment result has been obtained by taking the following steps: fabricating an original scale tape by applying 132.9 N/m of tensile force onto a PET film 2; as samples for the experiment, making twenty of small rolls E from the thus fabricated original scale tape; and calculating an average value of length from a roll core to a wrinkle in the tape with respect to the twenty of small rolls E. Similarly, the point F accounts for an experiment result with respect to a small roll F and the experiment result has been obtained by taking the following steps: fabricating an original scale tape by applying 149.5 N/m of tensile force onto a PET film 2; as samples for the experiment, making twenty of small rolls F from the thus fabricated original scale tape; and calculating an average value of length from a roll core to a wrinkle in the tape with respect to the twenty of small rolls F.

In FIG. 3, the point A directed to the small roll A indicates that a wrinkle occurs at a location 118.4 cm away from the roll core in the case of small tensile force of 83.1 N/m to the PET film 2. In this case, a wrinkle occurs in the usable portion of the double-sided adhesive tape 1. Therefore, the above indicated deficiency occurs if a small roll is made from the original scale tape fabricated in the above described manner.

The point B directed to the small roll B indicates that a wrinkle occurs at a location 101.3 cm away from the roll core in the case of tensile force of 91.4 N/m onto the PET film 2. In this case, a winkle is supposed to occur at the boarder of the unusable portion and the usable portion of the double-sided adhesive tape 1. Even if a small roll is made from the thus fabricated original scale tape and the small roll with such property is used as double-sided adhesive tape 1, serious deficiency can hardly occur. However, it is not positively recommended to use the double-sided adhesive tape 1 with such deficiency.

The point C directed to the small roll C indicates that a wrinkle occurs at a location 79.9 cm away from the roll core in the case of tensile force of 99.7 N/m to the PET film 2. In this case, a winkle is supposed to occur at the unusable portion only. Therefore, any deficiencies will not occur if the small roll made from the thus fabricated original scale tape is used as double-sided adhesive tape 1.

The point D directed to the small roll D indicates that a wrinkle occurs at a location 57.4 cm away from the roll core in the case of tensile force of 116.3 N/m to the PET film 2. In this case, a winkle is supposed to occur at the unusable portion only. Therefore, any deficiencies will not occur if the small roll made from the thus fabricated original scale tape is used as double-sided adhesive tape 1.

The point E directed to the small roll E indicates that a wrinkle occurs at a location 39.4 cm away from the roll core in the case of tensile force of 132.9 N/m to the PET film 2. In this case, a winkle is supposed to occur at the unusable portion only. Therefore, any deficiencies will not occur if the small roll made from the thus fabricated original scale tape is used as double-sided adhesive tape 1.

The point F directed to the small roll F indicates that a wrinkle occurs at a location 29.4 cm away from the roll core in the case of tensile force of 149.5 N/m to the PET film 2. In this case, a winkle is supposed to occur at the unusable portion only. Therefore, any deficiencies will not occur if the small roll made from the thus fabricated original scale tape is used as double-sided adhesive tape 1.

To sum up, as long as tensile force of 99.7 N/m or larger, for instance, 100 N/m or larger, is applied on the PET film 2 at the time of laminating the release sheet 2 thereon, occurrence of a winkle can reliably be avoided in a usable portion of a small roll made from original scale tape that holds the above mentioned tensile force, the usable portion being away from the roll core of the small roll by 100 cm or longer.

In a case where tensile force to be applied to the PET film 2 is 200 N/m or smaller, the extent of the PET film 2 expanding is held within favorable range. Consequently, there arises little difference between circumferential length of the PET film 2 and that of the release sheet 4 presenting exterior to the PET film 2 and this can avoid the PET film 2 from bearing a wrinkle at a usable portion of the double-sided adhesive tape 1. On the other hand, in a case where tensile force to be applied on the PET film 2 exceeds 200 N/m, the PET film 2 is too much expanded. Consequently, at the time of using the double-sided adhesive tape 1 that has been kept in storage for long time, springback occurs to the PET film 2, which eventually causes slack of the release sheet 4 and separation of the release sheet 4 from the first adhesive layer 3 while the double-sided adhesive tape 1 is being conveyed.

Next, there will be described on curling state of respective double-sided adhesive tapes kept in storage under the following condition, the respective double-sided adhesive tapes being unrolled and peeled off from the thus fabricated small rolls A through F.

Firstly, there will be described on measuring condition of curling state. Double-sided adhesive tapes of respective small rolls A through F have been unrolled and peeled off from their respective roll cores and cut off by predetermined length (for instance, 20 cm) so as to obtain tape pieces A through F. Next, each of the tape pieces A through F has been kept under 50% humidity atmosphere for 24 hours at 23 degrees Celsius. FIG. 4 shows curling state of each tape piece obtained under the above condition.

In FIG. 4, the tape piece A has been obtained from the small roll A fabricated by applying 83.1 N/m of tensile force to the PET film 2. Due to application of small tensile force, the curling state of the tape piece A is wide and curling diameter thereof is large.

The tape piece B has been obtained from the small roll B fabricated by applying 91.4 N/m of tensile force to the PET film 2. The curling diameter of the tape piece B is smaller than that of the tape piece A.

The tape piece C has been obtained from the small roll C fabricated by applying 99.7 N/m of tensile force to the PET film 2. The curling diameter of the tape piece C is smaller than that of the tape piece B.

The tape piece D has been obtained from the small roll D fabricated by applying 116.3 N/m of tensile force to the PET film 2. The curling diameter of the tape piece D is smaller than that of the tape piece C.

The tape piece E has been obtained from the small roll E fabricated by applying 132.9 N/m of tensile force to the PET film 2. The curling diameter of the tape piece E is smaller than that of the tape piece D.

The tape piece F has been obtained from the small roll F fabricated by applying 149.5 N/m of tensile force to the PET film 2. The curling diameter of the tape piece F is smaller than that of the tape piece E.

As apparent from the above results, curling diameter becomes smaller as tensile force to be applied to the PET film 2 at the moment of laminating the release sheet 4 onto the PET film 2 for fabricating an original scale tape is made larger.

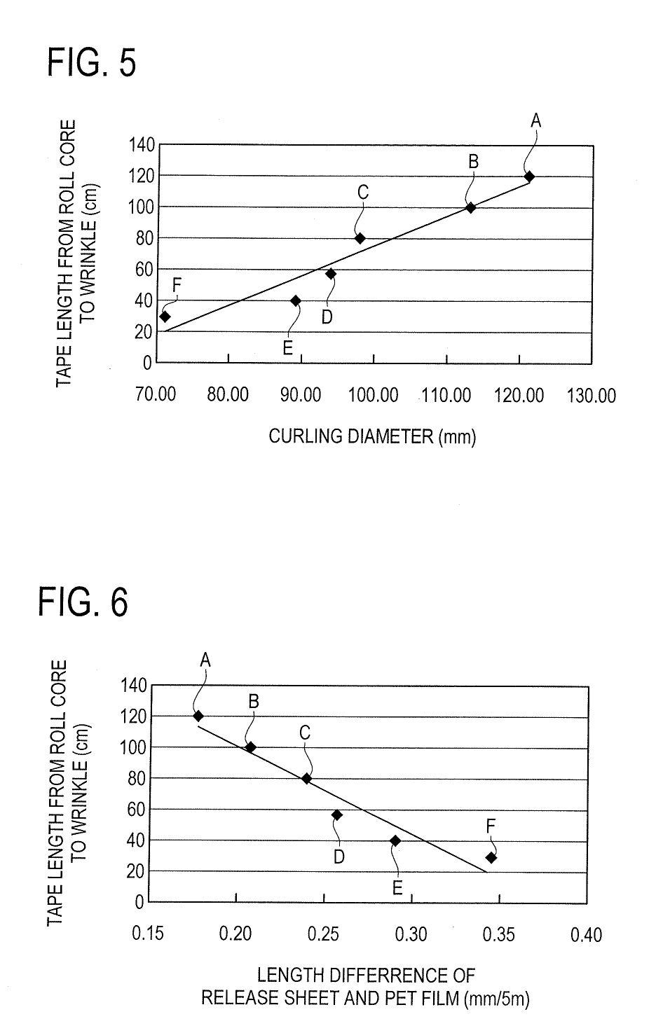

Photos of respective tape pieces A through F have been taken so as obtain clear curling-state images and image data of the respective tape pieces A through F have been taken into a personal computer so as to display there. By tracing an arc of each of the tape pieces A through F on the display, each of their outline has been clarified. It is to be noted that three trace samples have been created for each of the tape pieces A through F to obtain three of curling diameter values and calculate an average value of those three. FIG. 5 shows a graph of the measurement results.

Of the graph shown in FIG. 5, the abscissa indicates curling diameter value (mm) measured for the respective tape pieces A through F and the ordinate indicates tape length (cm) from a roll core to a portion that bears a wrinkle at outermost periphery of respective small rolls of double-sided adhesive tape 1.

In the graph of FIG. 5, the point A directed to the small roll A indicates that a wrinkle occurs at a location 118.4 cm away from the roll core in the case of large curling diameter of 121.0 mm. In this case a wrinkle occurs in the usable portion of the double-sided adhesive tape 1. Thereby, adhesive property deteriorates at the wrinkled usable portion and neatness is spoiled in a case where the double-sided adhesive tape 1 is used visibly and recognizably.

The point B directed to the small roll B indicates that a wrinkle occurs at a location 101.3 cm away from the roll core in the case of curling diameter of 113.0 mm. In this case, a winkle is supposed to occur at the boarder of the unusable portion and the usable portion of the double-sided adhesive tape 1. Even if the small roll B is used as double-sided adhesive tape 1, serious deficiency can hardly occur. However, it is not positively recommended to use the double-sided adhesive tape 1 with such deficiency.

The point C directed to the small roll C indicates that a wrinkle occurs at a location 79.9 cm away from the roll core in the case of curling diameter of 98.0 mm. In this case, a winkle is supposed to occur at the unusable portion only. Therefore, any deficiencies will not occur if the small roll C is used as double-sided adhesive tape 1.

The point D directed to the small roll D indicates that a wrinkle occurs at a location 57.4 cm away from the roll core in the case of curling diameter of 94.0 mm. In this case, a winkle is supposed to occur at the unusable portion only. Therefore, any deficiencies will not occur if the small roll D is used as double-sided adhesive tape 1.

The point E directed to the small roll E indicates that a wrinkle occurs at a location 39.4 cm away from the roll core in the case of curling diameter of 89.0 mm. In this case, a winkle is supposed to occur at the unusable portion only. Therefore, any deficiencies will not occur if the small roll E is used as double-sided adhesive tape 1.

The point F directed to the small roll F indicates that a wrinkle occurs at a location 29.4 cm away from the roll core in the case of curling diameter of 71.0 mm. In this case, a winkle is supposed to occur at the unusable portion only. Therefore, any deficiencies will not occur if the small roll F is used as double-sided adhesive tape 1.

To sum up, as long as curling diameter of the respective tape pieces A through F obtained under the above described condition is 113 mm or smaller, for instance. 110 mm or smaller, occurrence of a winkle can reliably be avoided in a usable portion of a small roll, the usable portion being away from the roll core of the small roll by 100 cm or longer.

In a case where curling diameter is 50 mm or larger, curvature of the double-sided adhesive tape 1 is held in favorable condition. Consequently, there arises little difference between circumferential length of the PET film 2 and that of the release sheet 4 presenting exterior to the PET film 2 and this can avoid the PET film 2 from bearing a wrinkle at a usable portion of the double-sided adhesive tape 1. On the other hand, in a case where curling diameter is 50 mm or smaller, curvature of the double-sided adhesive tape 1 becomes too large and the PET film 2 is too much expanded. Consequently, at the time of using the double-sided adhesive tape 1 that has been kept in storage for long time, springback occurs to the PET film 2, which eventually causes slack of the release sheet 4 and separation of the release sheet 4 from the first adhesive layer 3 while the double-sided adhesive tape 1 is being conveyed.

Next, it is considered that the PET film 2 of the double-sided adhesive tape 1 bears a wrinkle thereon due to circumferential difference between circumferential length of the release sheet 4 and that of the PET film 2. With this issue into consideration, there has been examined relation of the circumferential difference (mm) between circumferential length of the PET film 2 and that of the release sheet 4 and tape length (cm) from a roll core to a portion that bears a wrinkle with respect to each of small rolls A through F.

Here will be described on a method for measuring circumferential difference between circumferential length of the PET film 2 and that of the release sheet 4. For the measurement, the following steps have been taken: withdrawing a double-sided adhesive tape 1 from each of the small rolls A through F and cutting off by length longer than 5 m; making two of cuts in each double-sided adhesive tape 1 at a 5 m of interval therebetween: separating the PET film 2 and the release sheet 4 with respect to each double-sided adhesive tape 1; fixing one end of the PET film 2 and that of the release sheet 4 and hanging a 10 g weight on the other end of the PET film 2 and that of the release sheet 4; and measuring length between two cuts of the PET film 2 and length between two cuts of the release sheet 4 so as to obtain length difference of those. It is to be noted that three of samples have been prepared for each of the small rolls A through F so as to obtain an average value of length difference. A graph in FIG. 6 shows the measurement result.

Of the graph shown in FIG. 6, the abscissa indicates length difference (mm/5 m) of the PET film 2 and the release sheet 4 and the ordinate indicates tape length (cm) from a roll core to a portion that bears a wrinkle at outermost periphery of respective small rolls of double-sided adhesive tape 1.

In the graph of FIG. 6, the point A directed to the small roll A indicates that a wrinkle occurs at a location 118.4 cm away from the roll core in the case of small length difference of 0.177 mm, namely length difference between the 5 m-long PET film 2 and the 5 m-long release sheet 4. In this case a wrinkle occurs in the usable portion of the double-sided adhesive tape 1. Thereby, adhesive property deteriorates at the wrinkled usable portion and neatness is spoiled in a case where the double-sided adhesive tape 1 is used visibly and recognizably.

The point B directed to the small roll B indicates that a wrinkle occurs at a location 101.3 cm away from the roll core in the case of 0.206 mm difference between the 5 m-long PET film 2 and the 5 m-long release sheet 4. In this case, a winkle is supposed to occur at the boarder of the unusable portion and the usable portion of the double-sided adhesive tape 1. Even if the small roll B is used as double-sided adhesive tape 1, serious deficiency can hardly occur. However, it is not positively recommended to use the double-sided adhesive tape 1 with such deficiency.

The point C directed to the small roll C indicates that a wrinkle occurs at a location 79.9 cm away from the roll core in the case of 0.240 mm difference between the 5 m-long the PET film 2 and the 5 m-long release sheet 4. In this case, a winkle is supposed to occur at the unusable portion only. Therefore, any deficiencies will not occur if the small roll C is used as double-sided adhesive tape 1.

The point D directed to the small roll D indicates that a wrinkle occurs at a location 57.4 cm away from the roll core in the case of 0.258 mm difference between 5 m-long PET film 2 and the 5 m-long release sheet 4. In this case, a winkle is supposed to occur at the unusable portion only. Therefore, any deficiencies will not occur if the small roll D is used as double-sided adhesive tape 1.

The point E directed to the small roll E indicates that a wrinkle occurs at a location 39.4 cm away from the roll core in the case of 0.291 mm difference between 5 m-long of the PET film 2 and the 5 m-long release sheet 4. In this case, a winkle is supposed to occur at the unusable portion only. Therefore, any deficiencies will not occur if the small roll E is used as double-sided adhesive tape 1.

The point F directed to the small roll F indicates that a wrinkle occurs at a location 29.4 cm away from the roll core in the case of 0.346 mm difference between the 5 m-long PET film 2 and the 5 m-long release sheet 4. In this case, a winkle is supposed to occur at the unusable portion only. Therefore, any deficiencies will not occur if the small roll F is used as double-sided adhesive tape 1.

As mentioned above, when the length difference between the polyethylene terephthalate film 2 and the release sheet 4 of the double-sided adhesive tape 1 respectively derived from each of the small rolls A to F is 0.206 mm or larger, for example, 0.21 mm or larger, a wrinkle can be prevented from bearing in the usable portion exceeding 100 cm form the roll core in each of the small rolls A to F.

To sum up, in a case where length difference between the 5 m-long PET film 2 and the 5 m-long release sheet 4 is 0.35 mm or smaller, their length difference is held in a favorable range. Consequently, there arises little difference between circumferential length of the PET film 2 and that of the release sheet 4 presenting exterior to the PET film 2 and this can avoid the PET film 2 from bearing a wrinkle at a usable portion of the double-sided adhesive tape 1. On the other hand, in a case where length difference between the 5 m-long PET film 2 and the 5 m-long release sheet 4 is larger than 0.35 mm, the PET film 2 is too much expanded. Consequently, at the time of using the double-sided adhesive tape 1 that has been kept in storage for long time, springback occurs to the PET film 2, which eventually causes slack of the release sheet 4 and separation of the release sheet 4 from the first adhesive layer 3 while the double-sided adhesive tape 1 is being conveyed.

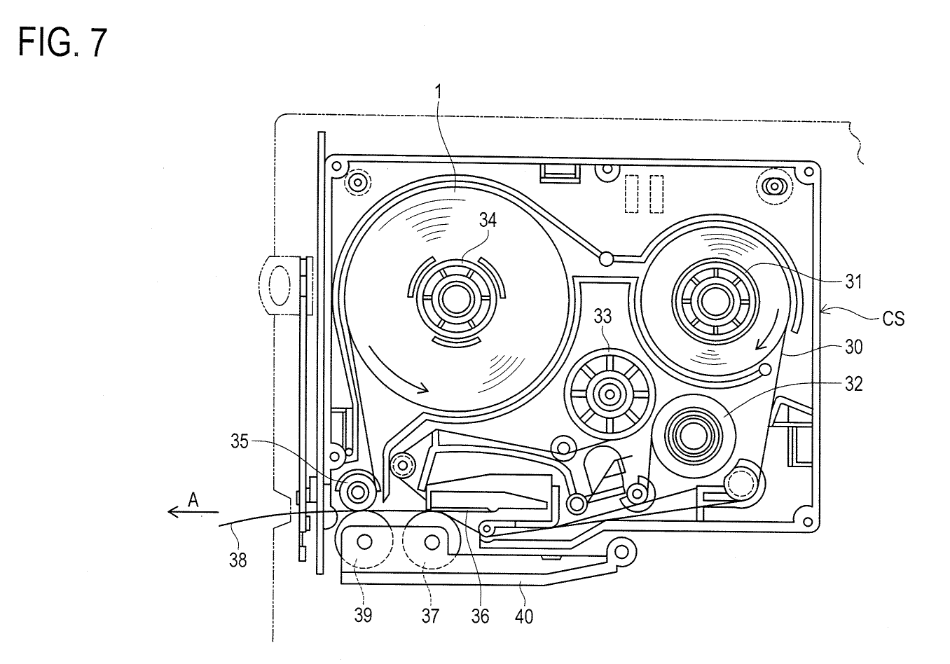

Each small roll of the thus configured double-sided adhesive tape 1 is used as tape to be accommodated in a tape cassette for a tape printing apparatus shown in FIG. 7.

Here will be described on a tape cassette employing a small of the double-sided adhesive tape 1 by referring to FIG. 7.

As shown in FIG. 7, a tape cassette CS is to be placed in a cassette insertion portion of a tape printing apparatus (not shown) in replaceable manner. The tape cassette CS is comprised of: a tape spool 31 onto which a transparent printing tape 30 is rolled; an ink ribbon 32 consisting of a base film and ink applied thereon, the ink being melt when heated; a take-up spool 33 taking-up the ink ribbon 32; a feed spool 34 onto which a double-sided adhesive tape 1 is rolled so as to make a release sheet turn outward, the double-sided adhesive tape 1 having the same width as the printing tape 30 (the spool corresponds to a roll core and the integration of the feed spool 34 and the double-side adhesive tape 1 rolled thereon corresponds to a small roll); and a bonding roller 35 that bonds the printing tape 30 and the double-sided adhesive tape 1 together for lamination. The tape spool 31, the feed spool 34 and the bonding roller 35 are rotatably arranged.

As already illustrated in FIG. 1, the double-sided adhesive tape 1 is comprised of: a polyethylene terephthalate (PET) film 2 as substrate film; a first adhesive layer 3 that is applied onto one surface of the PET film 2 (lower surface in FIG. 1); a release sheet 4 pasted onto the first adhesive layer 3; and a second adhesive layer 5 that is applied onto the other surface of the PET film 2 (upper surface in FIG. 1).

There is arranged upright a thermal head 36 that is mounted on the cassette insertion portion at the position where the printing tape 30 and the ink ribbon 32 meet each other. At the side of the tape printing apparatus, there are arranged a platen roller 37 for pressing the printing tape 30 and the ink ribbon 32 against the thermal head 36, and a conveying roller 39 for pressing the printing tape 30 and the double-sided adhesive tape 1 against the bonding roller 35 so as to create a printed tape 38. The platen roller 37 and the conveying roller 39 are rotatably supported by a supporting body 40 rotatably fixed to the tape printing apparatus. The thermal head 36 is comprised of heating element group, namely, 128 of heating elements (not shown) arranged in up-and-down direction (perpendicular to the tape surface).

In the above described configuration, the bonding roller 35 and the take-up spool 33 are rotated in a predetermined rotation direction along rotation of a tape feeding motor (not shown) in a predetermined direction. In synchronous with the rotation of those mechanical elements, the heating element group is electrically energized to heat the ink ribbon 32 with specific heating elements that have heated. Thereby, the ink applied onto the ink ribbon 32 is melted and characters, etc. are thermally transferred onto the printing tape 30. Further, the second adhesive layer 5 of the double-sided adhesive tape 1 is laminated onto the printing surface of the printing tape 30 by the bonding roller 35 and the conveying roller 39 and thus obtained printed tape 38 is conveyed along the tape conveying direction A.

While presently exemplary embodiments have been shown and described, it is to be understood that this disclosure is for the purpose of illustration and that various changes and modifications may be made without departing from the scope of the disclosure as set forth in the appended claims.

What is claimed is:

1. A double-sided adhesive tape rolled on a cylindrical roll core, the double-sided adhesive tape comprising:
a polyethylene terephthalate film having a first surface and a second surface opposite to the first surface;
a first adhesive layer applied on the first surface of the polyethylene terephthalate film;
a release sheet laminated on the first surface of the polyethylene terephthalate film through the first adhesive layer, the release sheet being laminated so as to turn exterior to the polyethylene terephthalate film; and
a second adhesive layer applied on the second surface of the polyethylene terephthalate film,
wherein 100 N/m or larger of tensile force is applied to the polyethylene terephthalate film when the release sheet is laminated onto the first adhesive layer applied on the first surface of the polyethylene terephthalate film.

2. The double-sided adhesive tape according to claim 1, wherein tensile force applied to the polyethylene terephthalate film is 200 N/m or smaller.

3. The double-sided adhesive tape according to claim 1,
wherein a tape piece obtained by unrolling and peeling off the double-sided adhesive tape from the roll core and cutting off by 20 cm length is adjusted to have 110 mm or smaller curling diameter measured after the tape piece has been kept for 24 hours under 50% humidity at 23 degrees Celsius.

4. The double-sided adhesive tape according to claim 3, wherein curling diameter of the tape piece is adjusted to be 50 mm or larger.

5. The double-sided adhesive tape according to claim 1,
wherein, in a case where a 10 g of weight is hung for predetermined time on a first end of each of a 5 m-long polyethylene terephthalate film and a 5 m-long release sheet while a second end of each being fixed, and length change of each is measured after passage of the predetermined time, length change difference between the 5 m-long polyethylene terephthalate film and the 5 m-long release sheet is adjust to be 0.21 mm or larger, the 5 m-long polyethylene terephthalate film and the 5 m-long release sheet being obtained by unrolling the double-sided adhesive tape from the roll core, cutting off by 5 m and separating the polyethylene terephthalate film and the release sheet.

6. The double-sided adhesive tape according to claim 5, wherein the length change difference between the 5 m-long polyethylene terephthalate film and the 5 m-long release sheet is made 0.35 mm or smaller.

7. The double-sided adhesive tape according to claim 1,
wherein the double-sided adhesive tape is defined by an unusable portion accounting for one portion from the roll core to reach predetermined length of distance on the double-sided adhesive tape and a usable portion accounting for other portion to exceed the predetermined length of distance from the roll core on the double-sided adhesive tape, and
wherein the polyethylene terephthalate film is prevented from bearing a wrinkle in the usable portion.

8. A tape cassette comprising:
a tape spool around which a transparent printing tape is wound;
an ink ribbon in which ink meltable by heating is coated on a base film;
a winding spool for winding the ink ribbon; and
a double-sided adhesive tape having a same width of the printing tape,
wherein the double-sided adhesive tape comprises:
a polyethylene terephthalate film having a first surface and a second surface opposite to the first surface;
a first adhesive layer applied on the first surface of the polyethylene terephthalate film;
a release sheet laminated on the first surface of the polyethylene terephthalate film through the first adhesive layer, the release sheet being laminated so as to turn exterior to the polyethylene terephthalate film; and
a second adhesive layer applied on the second surface of the polyethylene terephthalate film, and
wherein 100 N/m or larger of tensile force is applied to the polyethylene terephthalate film when the release sheet is laminated onto the first adhesive layer applied on the first surface of the polyethylene terephthalate film.

9. A producing method of a double-sided adhesive tape comprising: a polyethylene terephthalate film having a first surface and a second surface opposite to the first surface; a first adhesive layer applied on the first surface of the polyethylene terephthalate film; release sheet laminated on the first surface of the polyethylene terephthalate film through the first adhesive layer, the release sheet being laminated so as to turn exterior to the polyethylene terephthalate film and a second adhesive layer applied on the second surface of the polyethylene terephthalate film, the producing method comprising:
applying step for applying 100 N/m or larger of tensile force to the polyethylene terephthalate film before the release sheet is laminated; and
laminating step for laminating the release sheet onto the first adhesive layer applied on the first surface of the polyethylene terephthalate film.
